(19) United States
(12) Patent Application Publication
(10) Pub. No.: US 2020/0077708 A1
(43) Pub. Date: Mar. 12, 2020

(54) System for Gathering and Displaying Information about a Vaporizer Liquid

(71) Applicant: Evan E. Floyd, Carmichael, CA (US)

(72) Inventor: Evan E. Floyd, Carmichael, CA (US)

(21) Appl. No.: 16/567,457

(22) Filed: Sep. 11, 2019

Related U.S. Application Data
(60) Provisional application No. 62/729,670, filed on Sep. 11, 2018.

(51) Int. Cl. A24F 47/00; H04W 4/80; G06F 3/147; G06K 7/14; G06K 7/10

(52) U.S. Cl. CPC A24F 47/008; H04W 4/80; G06K 7/10366; G06K 7/1417; G06K 7/1413; G06F 3/147

(57) ABSTRACT

A cartridge of a vaporizing device, or at least a vaporizing liquid containing tank providing a portion of a cartridge (or otherwise provided as part of a vaporizing device) is provided with a recognizable code patch thereon. The housing of the vaporizing device or other receiver of the cartridge or other vaporizing liquid containing tank includes a sensor thereon. The sensor and code patch are brought sufficiently close (and/or aligned) together when the cartridge or other liquid containing vessel is attached to the housing of the vaporizing device to allow the sensor to “read” the code patch. This sensor is coupled to an output which can take one of various forms.

### RELATED APPLICATIONS

This application claims the benefit of priority to the United States Provisional Patent Application for “System for Gathering and Displaying Information about a Vaporizer Liquid,” Ser. No. 62/729,670, filed on Sep. 11, 2018, and currently co-pending.

### FIELD OF THE INVENTION

The present invention pertains generally to an electronic identification system for use in vaporizer cartridges. More particularly, the present invention pertains to a system for gathering and displaying information about a vaporizer liquid. The Present invention is particularly, but not exclusively, useful as a system for obtaining and displaying brand and flavor information about a vaporizer cartridge.

### BACKGROUND OF THE INVENTION

As a desirable alternative to smoking, vaporizers are known in the prior art. Such vaporizers do not rely on combustion of a solid or liquid substance, but rather have a heating element (also called a “coil”) which heats a substance (typically liquid) into a vapor. The vapor is then inhaled to provide the desired benefits. Vaporizers are beneficial over combustion based systems for various reasons, including avoiding all of the negative attributes of handling a burning substance, avoiding many of the toxic chemicals which are produced in typical combustion reactions, avoiding the need to dispose of ash and cigarette butts or other residual elements, and avoiding the need to carry along matches or some other combustion initiation device.

Because the substances being vaporized are typically liquids, they are typically provided separate from the vaporizer and connected to the vaporizer in some fashion. Options for such integration of the liquid (or other substance) being vaporized into the vaporizer device include preloaded cartridges of liquid removably attachable to a vaporizer housing. Standardized connectors are known in the prior art for facilitating the connection of preloaded cartridges of vaporizing liquids, so that the cartridges can be readily attached to a vaporizing device for enjoying of the vaporizer liquid.

Some of the details of the interconnection of these cartridges and the configuration of the cartridges themselves can vary in many ways. Some cartridges have a mouthpiece and heating element associated therewith. In other instances, a cartridge can have multiple separate parts and be disassembled, such as so that a user's mouthpiece can be removably attached to a liquid-containing tank, and perhaps removably attached to a heating element and a vaporizer housing port or other cartridge connection interface. A second main portion of the vaporizing device is a vaporizer housing which is typically provided in a “box” shape or in a “cylinder” shape. This housing of the vaporizing device typically includes a battery or other electric power source, and typically also a processor and electric interconnection circuitry to provide electric power to the heating element which is typically part of the cartridge.

It is conceivable that the heating element could be part of the housing of the vaporizing device, so that only a vaporizing liquid tank or tank and mouthpiece would attach to the heating element and other portions of the vaporizing device. In general, one can refer to the housing of the vaporizing device as being separate from the cartridge of the vaporizing device, with removable attachability therebetween typically through a standard interface.

One problem with prior art vaporizing devices is that the vaporizing device, once loaded, does not have easy and useful ways to communicate to a user what liquid is being used within the vaporizing device. In contrast, when smoking a cigarette, a user can look at a pack that the cigarette came out of or even the cigarette itself to see which brand is being enjoyed. Because the vaporizing device is provided separate from the liquid being vaporized, the vaporizing device does not communicate which “brand” of liquid is being enjoyed. Moreover, the cartridges containing the vaporizer liquid are often too small to provide a clearly visible brand name or other information to a user. Thus, a user faces the frustration of finding a liquid to be particularly enjoyable, but not knowing exactly which brand of liquid is being enjoyed, or being able to study other characteristics or attributes of the liquid being enjoyed. Conversely, when a liquid is found to be undesirable by a user, the user is not able to readily identify the brand of the liquid, or other attributes of the liquid, so that the user can avoid such brands or avoid vaporizing liquids having other undesirable liquid identifying characteristics.

Not only is this problem frustrating to the user of the vaporizing device, and consumer of the vaporizing liquid, this problem also represents a missed opportunity for providers of quality vaporizing liquids to advertise their products and to communicate the brand of vaporizing liquid being used, or to communicate other attributes of the vaporizing device and liquid to consumers while the vaporizing liquid is being enjoyed.

### SUMMARY OF THE INVENTION

With this invention, a cartridge of a vaporizing device, or at least a vaporizing liquid containing tank providing a portion of a cartridge (or otherwise provided as part of a vaporizing device) is provided with a recognizable code patch thereon. The housing of the vaporizing device or other receiver of the cartridge or other vaporizing liquid containing tank includes a sensor thereon. The sensor and code patch are brought sufficiently close (and/or aligned) together when the cartridge or other liquid containing vessel is attached to the housing of the vaporizing device to allow the sensor to “read” the code patch. This sensor is coupled to an output which can take one of various forms according to this invention, and as described below.

With regard to the code patch and sensor, in one embodiment the code patch is a barcode such as those commonly provided on goods packaging (some such “barcodes” are provided by the GS1 company). The sensor is typically an optical scanner or other form of scanner which can read a barcode or other code patch. The number or other indicia associated with this barcode is provided to initiate the output, as described below.

In another embodiment, the code patch is in the form of a two-dimensional barcode, QR code, or other machine readable encoding system. In one embodiment, the code patch is simply a multi-digit number or a multi-letter string, or mixture of letters and numbers (or other characters), such as as similar to a vehicle license plate, or other numbering system. The sensor is properly configured to read such codes so that input is provided into the system of this invention which correlates with the liquid contained within the cartridge or other liquid containing vessel of the vaporizing system.

In a further alternative system, the code patch is an RFID (Radio Frequency Identification) system and the sensor is an RFID antenna/sensor or transceiver. Thus, visual, radio, or other data transfer methods allow the code patch and sensor to communicate the code corresponding with the vaporizing liquid in the cartridge or vessel.

The output of the system can be configured in a variety of ways, with the ultimate objective being to communicate to the user of the vaporizing system information about the vaporizer liquid which correlates with the code provided on the code patch of the cartridge or other vaporizing liquid (or solid) containing structure removably attachable to the vaporizer housing or other portions of the vaporizing device. In one embodiment, an application (“app”) is provided which operates on a smartphone, and which includes a database of information, either within memory associated with the app, or which app accesses a database separate from the smartphone (i.e. through the Internet or otherwise, but typically wirelessly) with the app able to call up and retrieve data from this database upon request.

The database contains information about various different vaporizing liquids, with each field of information associated with each vaporizing liquid also having the particular code associated with the code patch that is correlated with this information within the database. The app can also be configured to display information from the database on a display of the smartphone or other smart device, in one embodiment.

In preferred embodiments, a transmitter is provided within the vaporizer housing which communicates with a processor within the vaporizer housing which is also coupled to the patch sensor. In some embodiments, the transmitter is a Bluetooth transmitter, or other radio frequency or other electromagnetic or other wireless transmission system. Some embodiments include multiple transmitters in order to support multiple communications frameworks, such as Bluetooth and Wi-Fi, allowing the user flexibility to use the vaporizer's communication features with a greater variety of computing devices. Some embodiments include the capability of passing a signal wire, such as a USB or FireWire cable, from the vaporizer housing to a smartphone or other smart device, or to a desktop computer or other special purpose device. The code is then transferred to the smartphone or other smart device (or other device) and utilized to access the database within the app, or by the app communicating with a separate database, so that the information in the database associated with that code can be passed back to smart device for display on the smart device.

In one embodiment, this information is further passed back to the housing of the vaporizer for display on a display of the vaporizer housing. In either such embodiment, a user can observe a screen of the smartphone or other device, or the display on the vaporizer housing and readily see which brand of the vaporizing liquid is being enjoyed, and, in some preferred embodiments, other attributes of the vaporizer liquid being enjoyed. In some embodiments, such information includes an expiration date for the liquid, a date of manufacture of the liquid, lot numbers for the liquid, phone numbers, email addresses, and other contact information (e.g. hypertext links) to allow users to provide feedback about the vaporizing liquid, such as back to a manufacturer of the vaporizing liquid. Furthermore, in some embodiments such information includes re-ordering information so the user who wishes to re-order more of a vaporizing liquid which has been enjoyed, can order more of the same present liquid. In some embodiments, with at least some cartridges locations where the vaporizer liquid is carried in stock is provided, including information such as maps, phone numbers, etc. which direct the user to where the vaporizer liquid can be found for purchase. In some embodiments, a vaporizing liquid manufacturer or other party can provide one or more selections of music and cause the music to be played on the smart device (or on the vaping device), so that manufacturer recommended music can be enjoyed while the vaporizing liquid is being consumed.

When the cartridge or other vaporizing liquid containing vessel is removed from the vaporizing device and replaced with a new cartridge or other vessel, a new code patch is presented adjacent to the sensor of the housing. The system will then repeat the process as described above, communicating the code on the code patch through the sensor to the processor of the vaporizing device and or directly to a transmitter, for transmitting, such as to a smartphone or other device, and for identification of corresponding vaporizing liquid information associated with the new cartridge, being presented on the display of the smartphone or other smart device (or transmitted back to the vaporizing device for display on the display of the vaporizer housing). In this manner, a user can always see the brand and other useful information about the precise vaporizing liquid being enjoyed.

Other features of this invention, which might be enabled upon the authorization of the user, might include the app collecting information about who is enjoying the vaporizing liquid. Such information includes, depending on the embodiment, one or more of: where the particular vaporizing liquid is being enjoyed, when it is being enjoyed, whether the user is a repeat customer or a new customer, how close to empty the cartridge is, and other information such as other vaporizing liquids which this user has utilized previously, and other useful information. This information can then be used as part of general marketing efforts, such as rewarding regular users, providing coupons or other enticements, especially to new users to encourage repeat purchases, to advertise the availability of related services nearby where the user is located, otherwise provide services to the user and to further improve the overall vaping experience.

Some embodiments of the application also present the user with an option to “subscribe” to the vaporizer liquid being enjoyed, or other liquids at the user's option. By electing to subscribe to the liquid, the user would receive automatic repeated deliveries of the product at selected quantities and intervals of time.

While many embodiments of this invention are envisioned as operating with a separate smart device, in an alternative embodiment, the housing of the vaporizing device itself includes a memory and/or ability to access the database, so that a display on the vaporizing device is able to display information about the vaporizing liquid being enjoyed, with such information either called up from a database stored in memory of the vaporizing device itself (and loaded periodically into the memory), or information provided from a separate database. In such a case, the vaporizing device is configured to communicate (either wirelessly or through wired connection) to the database to receive information about the vaporizing liquid being enjoyed. As an example, an embodiment of the vaporizing device includes a cellular data antenna and utilize cellular phone data transfer technology to access the database and obtain information from the database correlated with the code sensed on the code patch of the cartridge, which is connected to the vaporizer housing. Similarly, in some embodiments a Wi-Fi antenna is utilized for such downloading of information for display on a display on the housing of the vaporizing device.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When embodiments are referred to as “exemplary” or “preferred” this term is meant to indicate one example of the invention, and does not exclude other possible embodiments. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates an exemplary vaporizer design, showing components of a vaporizer;

FIG. 2 illustrates another design for a vaporizer housing;

FIG. 3 illustrates the components of a vaporizer implementing a system for gathering and displaying information about a vaporizer liquid;

FIG. 4 illustrates a vaporizer pen design;

FIG. 5 illustrates the components of a vaporizer;

FIG. 6 illustrates a pod vaporizer design;

FIG. 7 illustrates another pod vaporizer design;

FIG. 8 illustrates another pod vaporizer design showing the separate components of pod vaporizers;

FIG. 9 is a diagram illustrating the interaction between various components involved in gathering and displaying information about a vaporizer liquid;

FIG. 10 illustrates a preferred embodiment of a code patch in the form of a barcode;

FIG. 11 illustrates a preferred embodiment of a code patch in the form of a QR code;

FIG. 12 illustrates a preferred embodiment of a code patch in the form of an RFID tag;

FIG. 13 is a flowchart illustrating a process of gathering and displaying information about a vaporizer cartridge as performed by a preferred embodiment of a system for gathering and displaying information about a vaporizer liquid;

FIG. 14 is a flowchart further detailing process steps for obtaining information about a vaporizer cartridge; and

FIG. 15 illustrates some exemplary user interface elements of an application displaying vaporizer liquid information on a personal computing device.

### DETAILED DESCRIPTION

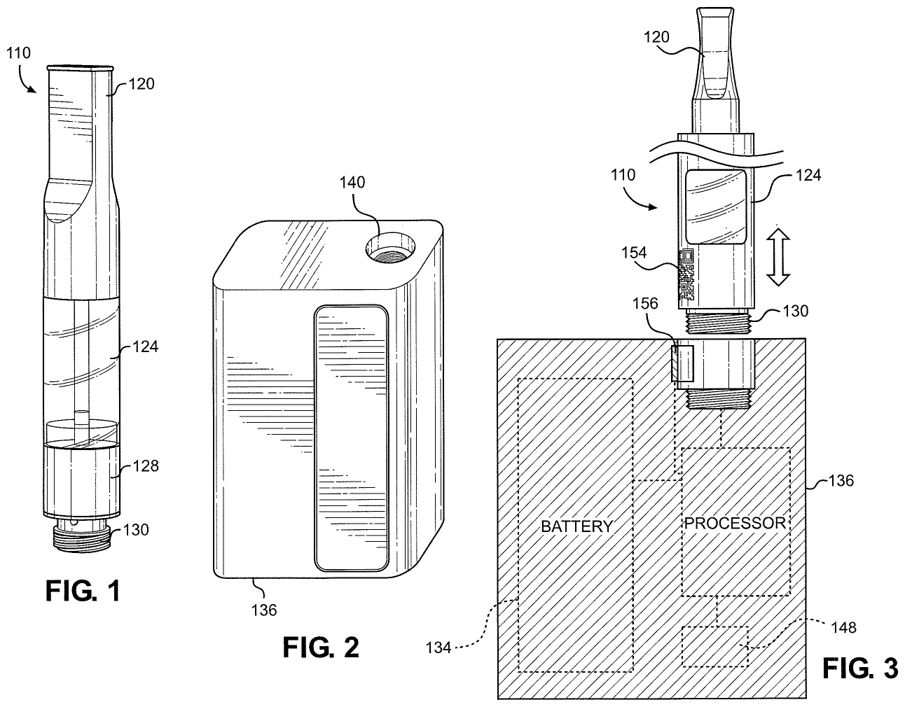

Referring initially to FIG. 1, a portion of a vaporizer 100 is illustrated and generally designated as cartridge module 110. Cartridge module 110 of vaporizer 100 generally includes a mouthpiece 120, a cartridge 124 containing vaporizer liquid, and a heating element 128 to heat the vaporizer liquid. The heating element 128 of the vaporizer 100 illustrated in FIG. 1 contains a connector 130 having threads for connection to a battery 132 (not shown in FIG. 1) in order to provide energy to the heating element 128.

Referring now to FIG. 2, a vaporizer battery 132 (shown in FIG. 3) and a heating element 128 are often installed in a vaporizer housing 136. Alternatively, in some embodiments the heating element 128 is directly attached to the cartridge 124 as part of cartridge module 110 rather than contained in housing 136. A cartridge port 140 on vaporizing housing 136 allows for a cartridge 124 containing vaporizer liquid to be removably attached to the vaporizer housing 136, and in turn connected to the heating element 128 (if inside the housing) and the battery 132.

Referring now to FIG. 3, vaporizer housing 136 contains a battery 132, and electronic circuitry 144, including a communications apparatus 148, such as a transmitter. Electronic circuitry 144 also includes heating element 128 in some embodiments; in others, heating element 128 forms part of a cartridge module 150. Cartridge module 110 includes a mouthpiece 120, cartridge 124 containing vaporizer liquid, heating element 128 in some embodiments, and a connector 130 to connect cartridge module 110 to vaporizer housing 136. Moreover, cartridge module 150 contains a code patch 154 readable by a patch sensor 156 located in vaporizer housing 136.

When a cartridge module 110 is connected to vaporizer housing 136, code patch 154 is read by patch sensor 156 in conjunction with electronic circuitry 144. In its simplest embodiment, code patch 154 simply contains an identifier code such as a database key. The code is sent to an external device through communications apparatus 148 in order to obtain and display information associated with the code contained in code patch 154. In other preferred embodiments, code patch 154 contains more detailed information, allowing the display of at least some information about the contents of cartridge 124 even in the absence of the availability of an external device, or in circumstances in which the external device is unable to look up information associated with the code.

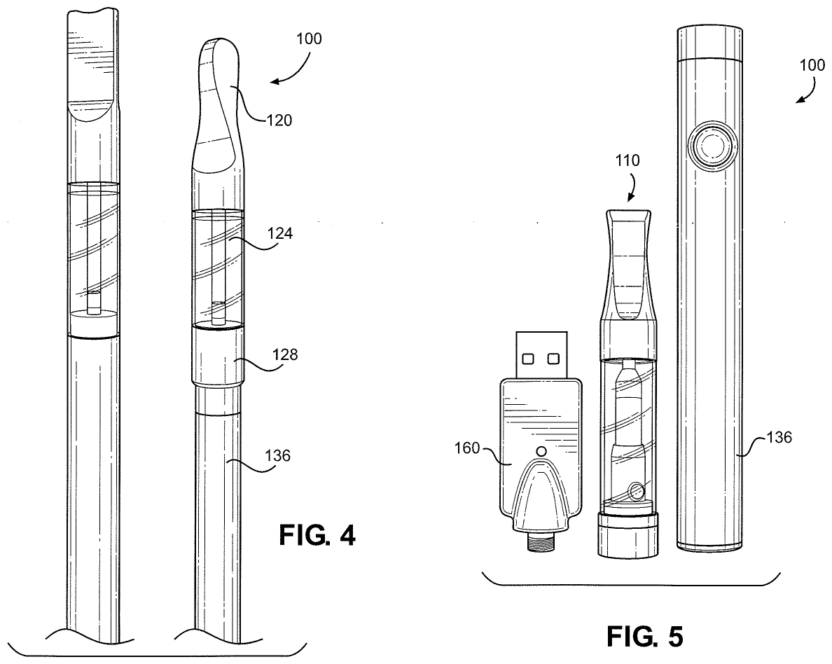

Referring now to FIG. 4, a vaporizer 100 having a pen design is illustrated. In a preferred embodiment of a pen-vaporizer-based system for gathering and displaying information about a vaporizer liquid, the code patch 154 is located on the base of the cartridge 110, around the connector 130. The corresponding patch sensor 156 is located on the top of the vaporizer housing 136. In an exemplary embodiment, the code patch 154 is a barcode that deviates slightly from standard barcodes in being curved sufficiently for placement around the connector 130.

Referring now to FIG. 5, components a vaporizer 100 are illustrated. A cartridge module 110 is shown detached from a vaporizer housing 136 containing a battery 132 and electronic circuitry 144. A charger 160, illustrated as a USB charger, attaches to a connector on the bottom of housing 136 in order to charge battery 132. As with vaporizer 100 of FIG. 4, code patch 154 is located on the base of cartridge module 110, and patch sensor 156 is located on the top of cartridge housing 136.

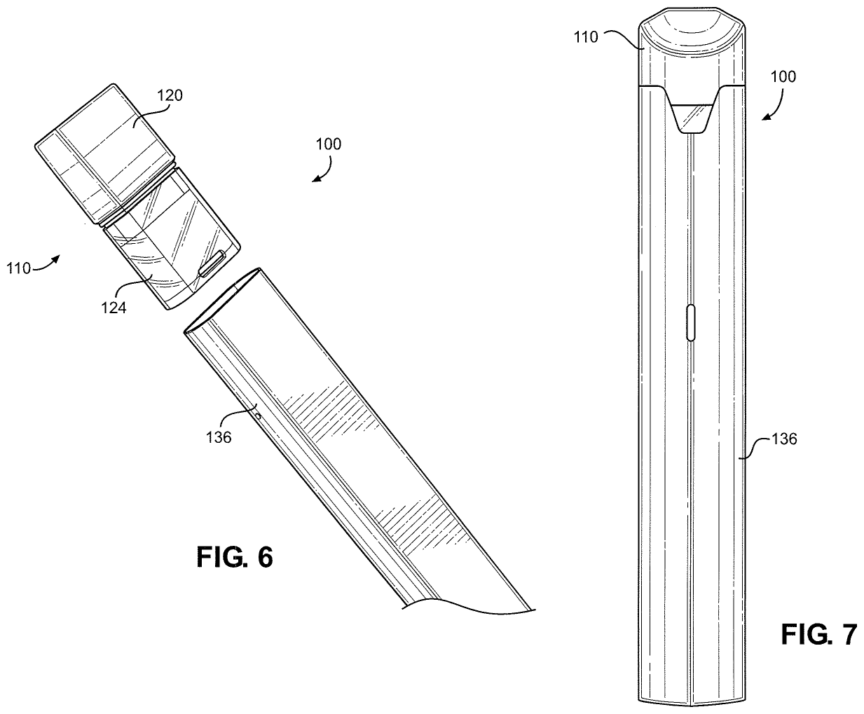

Referring now to FIG. 6, a “pod” vaporizer 100 is illustrated, in which cartridge module 110, referred to as the “pod” attaches by insertion to vaporizer housing 136 containing the battery 132. A code patch 154 is located either on the base of cartridge module 110, or on a portion of the side that is inserted into the vaporizer housing 136, depending on the embodiment; the patch sensor 156 is located in the vaporizer housing 136 in a location suitable for reading code patch 154 upon insertion of the cartridge module 110.

Referring now to FIG. 7, another “pod” vaporizer 100 is illustrated, showing the “pod” cartridge module 110 inserted into the vaporizer housing 136.

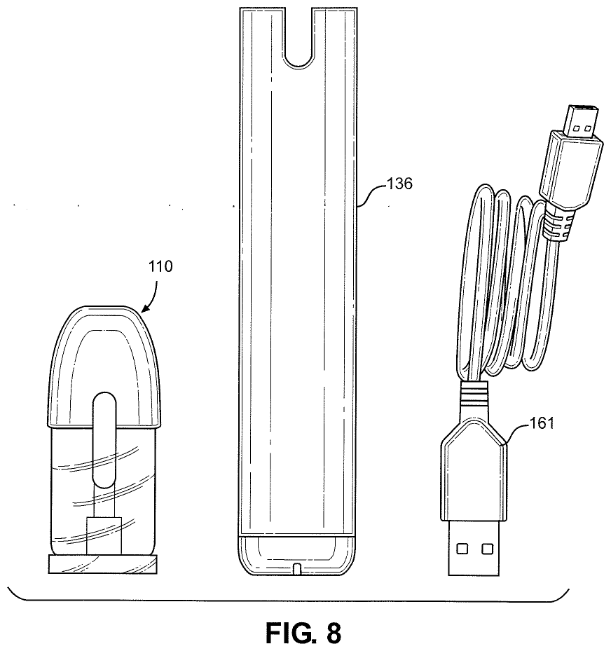

Referring now to FIG. 8, a breakdown of a “pod” vaporizer 100 is illustrated, showing the “pod” cartridge module 110 disconnected from the vaporizer housing 136. A USB charging cable 161 is shown; the electronic circuitry of charger 160 is built into the vaporizer housing 136.

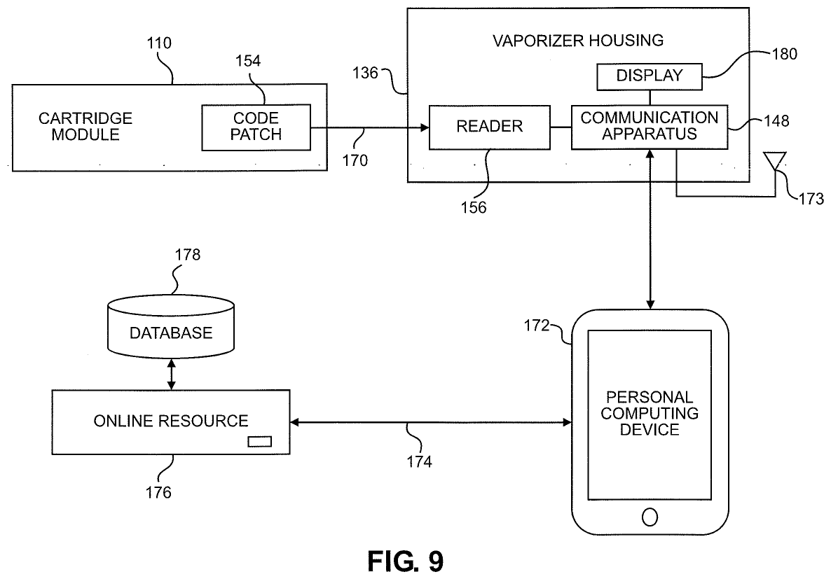

Referring now to FIG. 9, a conceptual diagram of a preferred embodiment of a system for gathering and displaying information about a vaporizer liquid is illustrated. A code patch 154 on a cartridge module 110 contains data 170 which is read by patch sensor 156 in vaporizer housing 136. In preferred embodiments the data 170 on the code patch 154 contains at least an identifier, such as a database key, associated with additional data 170 describing the contents of the cartridge 124 in the cartridge module 110.

The manner in which data 170 is transferred from code patch 154 to reader 156 is dependent on the type of code patch 154 and reader 156. In embodiments in which code patch 154 is a barcode, a QR code, text, or another form of visual data encoding, reader 156 is generally an optical scanner. In some embodiments, reader 156 and supporting circuitry in the vaporizer housing 136 is capable of scanning, identifying, and decoding more than one type of code patch 154. For example, one embodiment of vaporizer 100 supports cartridge modules 110 with code patches 154 that are barcodes, as well as cartridge modules 110 with code patches 154 that are QR codes. Other embodiments supporting each of the other possible combinations are fully contemplated.

In some embodiments, code patch 154 is an RFID tag, and data 170 is transferred from code patch 154 to reader 156 in response to a query from reader 156 transmitted as a radio signal.

Some embodiments of reader 156 include both an optical scanner and an RFID reader, enabling the vaporizer 100 to support both cartridge modules 110 with visually encoded data 170 in code patch 154 and cartridge modules with an RFID tag for code patch 154.

The data obtained from code patch 154 is sent to a personal computing device 172 using a communication apparatus 148 in the vaporizer housing 136. In a preferred embodiment, personal computing device 172 is a mobile phone running an application configured to receive and act upon data originating from code patch 154, and communication apparatus 148 is or includes a Bluetooth radio. In preferred embodiments, vaporizer 100 communicates with computing device 172 wirelessly, through Bluetooth, Wi-Fi, another form of wireless communication, or a combination thereof. Accordingly, in such embodiments vaporizer housing 136 will also have one or more antennas 173 attached to the one or more radios of communication apparatus 148 in order to support wireless communications.

In some embodiments, a copy of the data associated with the identifier is located in a database on the personal computing device 172 itself accessible to the application that receives the data originating from code patch 154 through communication apparatus 148. This allows for the display of the cartridge 124 contents in situations in which access to additional resources, such as the Internet, is unavailable. Where available, in preferred embodiments the application running on personal computing device 172 accesses an online resource 176 through data link 174, which provides information associated with the identifier from a database 178. In a preferred embodiment, online resource 176 also provides the application with additional information and resources for display on the personal computing device 172, such as advertisements and coupons for additional vaporizer cartridges 124 with the same or similar flavors of vaporizer liquid, opportunities for online purchase of vaporizer cartridges 124, vaporizers 100, or accessories, or other information or offers that may be of interest to the user.

In preferred embodiments, data link 174 between personal computing device 172 and online resource 176 is the Internet, although the use of local, private, and other proprietary networks is fully contemplated. In preferred embodiments, personal computing device 172 is capable of accessing the Internet through Wi-Fi, cellular bands, or both. In some alternative embodiments, personal computing device 172 has a wired connection to the Internet. In preferred embodiments, the application running on personal computing device 172 to communicate with vaporizer 100 and online resource 176 is connection-agnostic, meaning that it accesses the Internet through the Internet Protocol (IP) stack running on an operating system on personal computing device 172; accordingly the Internet connection can be any form of Internet connection known in the art and supported by personal computing device 172 without affecting the functionality of the application.

In some preferred embodiments, vaporizer housing 136 has a display 180, such as a liquid crystal display (“LCD”) or other type of screen, capable of indicating to the user information about the vaporizer cartridge 124 currently connected to the vaporizer housing 136. In exemplary embodiments, this information is provided back to the vaporizer housing 136 by the personal computing device 172 through communication apparatus 148 after the application on the personal computing device 172 acquires the data associated with the identifier from the code patch 154. In some embodiments, if information about the cartridge 124 is encoded directly into code patch 154, the vaporizer housing 136 is able to display the information directly from the code patch 154 in the absence of a communications connection to the personal computing device 172. Some embodiments having a communication apparatus 148 with Wi-Fi or cellular network capabilities are further able to access the Internet directly, without the mediation of personal computing device 172, in order to communicate with online resource 176 to send the data associated with code patch 154 and receive and display information about vaporizer cartridge 124 and its contents.

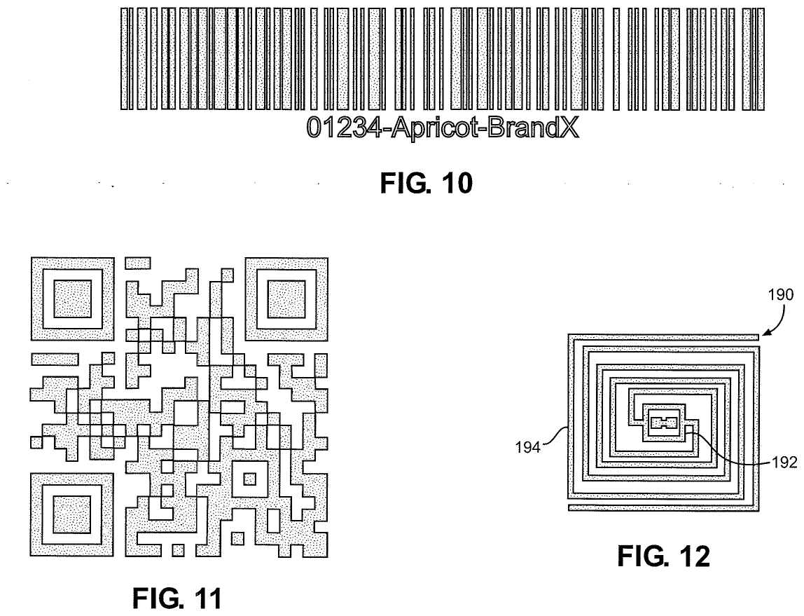

Referring now to FIGS. 10-12, some preferred embodiments of code patch 154 are illustrated.

As shown in FIG. 10, a preferred embodiment of code patch 154 is a barcode. Any form of barcode that can encode a unique identifier is suitable for use in a system for gathering and displaying information about a vaporizer liquid. Some barcodes, such as the “Code 128” barcode illustrated, can further encode additional characters. Some embodiments with space for a sufficiently large code patch 154 is available, or a patch sensor 156 capable of resolving sufficiently fine detail, will use such a bar code to encode information about the contents of the cartridge 124 in addition to the unique code identifier, thus enabling display of at least some information about the vaporizer liquid in cartridge 124 in the absence of the ability to acquire further information from online resource 176 or, with some vaporizer housings 136, even in the absence of a connection to personal computing device 172. For example, the illustrated bar code contains an exemplary identifier code “01234” as well as a flavor “Apricot” and a brand name “BrandX.” If the particular circumstances at a given moment prevent the lookup of data associated with the identifier code “01234,” the flavor “Apricot” and the brand name “BrandX” can still be displayed to the vaporizer user, whether on a personal computing device 172 or on a built-in display on the vaporizer housing 136 itself.

As shown in FIG. 11, another preferred embodiment of code patch 154 is a QR code. Various versions of QR code have various capacities for data representation. For example, where space is limited, such as on a pen-shaped vaporizer, a micro QR code containing only an identifier code may be used. QR codes may also contain additional information, such as the illustrated version 2 QR code, which contains the exemplary identifier code “01234,” the flavor “Apricot,” and the brand name “BrandX,” as also illustrated with the barcode in FIG. 10. Using the error correction capabilities of QR codes, a logo or other illustration may also be placed on the QR code of a code patch 154 for aesthetic purposes.

As illustrated in FIG. 12, another preferred embodiment of code patch 154 is an RFID tag 190 containing an identifier code which can be associated with further data related to the vaporizer liquid in cartridge 124. In some embodiments, the RFID tag 190 also contains further information that can be displayed in the absence of the ability to access the further information associated with the identifier code.

RFID tag 190 has an integrated circuit 192 and an antenna 194 operative to receive a query from reader 156 (shown in FIG. 9) and provide a response. In a preferred embodiment, RFID tag 190 is powered by the radio signal from the query of reader 156, obviating the need for an internal power source such as a battery, and allowing RFID tag 190 to be much smaller.

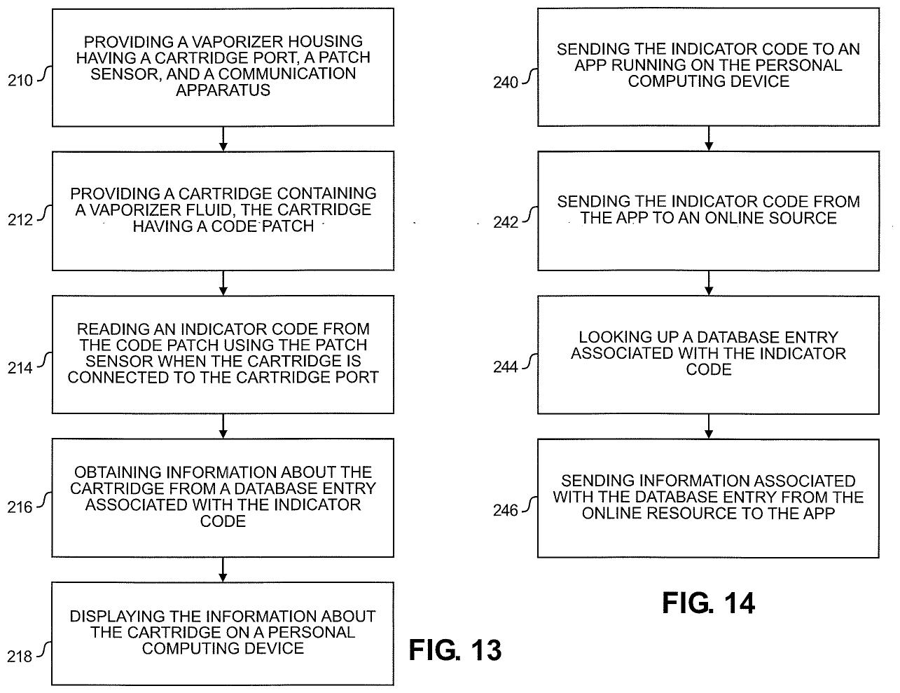

Referring now to FIG. 13, a flowchart illustrating a process for gathering and displaying information about a vaporizer cartridge is shown. Step 210 of the process involves providing a vaporizer housing 136 with a cartridge port 140, a patch sensor 156, and a communication apparatus 148. Step 212 involves providing a cartridge module 110, which has a cartridge 124 containing a vaporizer fluid, and a code patch 154 containing an indicator code.

In step 214, when the cartridge module 110 is connected to the cartridge port 140, the patch sensor 156 reads the indicator code from the code patch 154. After the indicator code is obtained, step 216 is performed, in which information about the cartridge module 110, and more specifically, about the vaporizer fluid in cartridge 124, is obtained from a database entry associated with the indicator code. Step 216 is outlined in greater detail as a series of sub-steps in FIG. 14.

The information retrieved from the database entry associated with the indicator code generally includes flavor and brand information about the cartridge module 110 and its contents. After information about the cartridge module 110 is obtained in step 216, the information retrieved is displayed on a personal computing device, such as a mobile phone, in step 218.

Referring now to FIG. 14, a preferred embodiment of process for performing step 216 of FIG. 13 is illustrated. In order to use the indicator code to obtain cartridge information, the indicator code is sent to an app running on a personal computing device 172, as illustrated by step 240. Step 240 is performed by a communication apparatus 148 housed in the vaporizer housing 136. In step 242, the app sends the indicator code to an online resource 176, which in turn performs step 244 by looking up, in database 178, a database entry associated with the indicator code. The information contained in the database entry generally includes at least brand and flavor information for the vaporizer fluid in cartridge 124. This information is parsed by the online resource, placed in a format recognizable by the app, and sent to the app in step 246. Upon receipt of the information, the app performs step 218 of FIG. 13, displaying at least a portion of the information on the display of personal computing device 172.

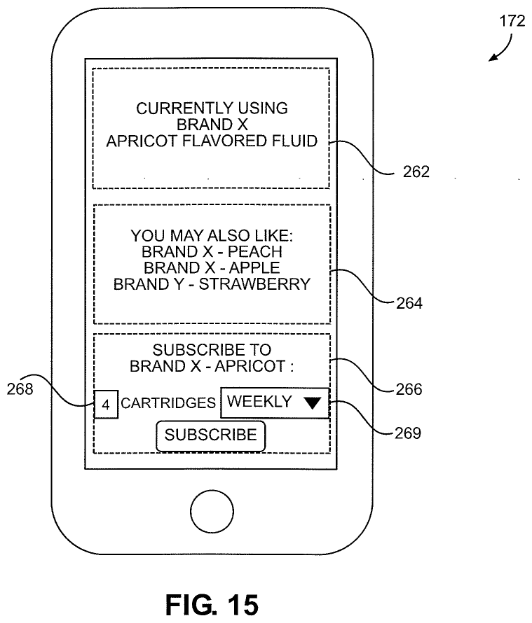

Referring now to FIG. 15, an application (or “app”) running on a personal computing device 172 displays information about the vaporizer fluid in cartridge module 110, as illustrated by user interface element 262. Preferred embodiments of the app also display additional information and offers, such as related products 264, subscription options 266, advertisements, coupons, other marketing or promotional materials, or combinations of the foregoing. In some preferred embodiments, subscription options 266 allow the user to adjust the number 268 of cartridges or refills for delivery to the user, and the frequency 269 of deliveries.

While there have been shown what are presently considered to be preferred embodiments of the present invention, it will be apparent to those skilled in the art that various changes and modifications can be made herein without departing from the scope and spirit of the invention.

What is claimed is:

1. A vaporizer, comprising:
a vaporizer housing;
a cartridge port on the vaporizer housing;
a patch sensor on the vaporizer housing, the patch sensor configured to read an indicator code from a code patch on a cartridge connected to the cartridge port.

2. The vaporizer as recited in claim 1, further comprising a communication apparatus configured to communicate the indicator code to a personal computing device.

3. The vaporizer as recited in claim 2, wherein the communication apparatus comprises a Bluetooth radio.

4. The vaporizer as recited in claim 1, further comprising a screen configured to display information that the patch sensor reads from the code patch.

5. The vaporizer as recited in claim 1, further comprising a screen configured to display information associated with the indicator code from the code patch.

6. The vaporizer as recited in claim 5, further comprising a communication apparatus configured to communicate the indicator code to a personal computing device, wherein the displayed information associated with the indicator code from the code patch is received from the personal computing device in response to the indicator code being communicated to the personal computing device.

7. The vaporizer as recited in claim 1, wherein the code patch is a data source selected from the group consisting of a bar code, a QR code, and an RFID tag.

8. A vaporizing device, comprising:
a cartridge including at least a vaporizer liquid containing vessel;
a vaporizer housing including a port through which the cartridge is removably attachable;
a power supply;
a heating element coupled to the power supply and the vaporizing liquid containing vessel;
a mouthpiece for outputting vaporized liquid coming into contact with the heating element;
a code patch on the cartridge;
a patch sensor on the vaporizer housing and adjacent to the code patch and sufficiently close to the code patch to read the code patch when the cartridge is placed into the port of the housing;
a transmitter for transmitting information correlating with the code patch to a smart device; and
an app running on the smart device and configured to correlate the code received from the transmitter with information correlating with the vaporizing liquid within the cartridge and display the information on a display of the smart device.

9. The vaporizing device as recited in claim 8, wherein the code patch is a data source selected from the group consisting of a bar code, a QR code, and an RFID tag.

10. The vaporizing device as recited in claim 9, wherein the code patch comprises data comprising an indicator code that identifies a database entry containing brand and flavor information about the vaporizing liquid.

11. The vaporizing device as recited in claim 10, wherein the code patch further comprises data comprising a brand and a flavor of the vaporizing liquid, and wherein the app displays the brand and flavor obtained from the code patch when the app is unable to access the database entry.

12. A system for gathering and displaying information about a vaporizer liquid, comprising:
a vaporizer, comprising:
a vaporizer housing having a cartridge port for a vaporizer liquid cartridge,
a patch sensor, and
a communication apparatus;
at least one cartridge having a code patch positioned to be read by the patch sensor when the cartridge is inserted into the cartridge port;
an app configured to run on a personal computing device; and
an online resource,
wherein the patch sensor is configured to read an indicator code from the code patch of a cartridge of the at least one cartridge when the cartridge is inserted into the cartridge port,
wherein the communication apparatus is configured to send the indicator code read by the patch sensor to the app,
wherein the app is configured to send the indicator code to the online resource,
wherein the online resource is configured to respond to receipt of an indicator code by sending brand and flavor information associated with the cartridge to the app, and
wherein the app is configured to display the brand and flavor information received from the online resource on the personal computing device.

13. The system for gathering and displaying information about a vaporizer liquid as recited in claim 12, wherein the code patch is a data source selected from the group consisting of a bar code, a QR code, and an RFID tag.

14. The system for gathering and displaying information about a vaporizer liquid as recited in claim 12, wherein the communication apparatus comprises a Bluetooth radio.

15. The system for gathering and displaying information about a vaporizer liquid as recited in claim 12, wherein the indicator code identifies a database entry containing brand and flavor information associated with the cartridge.

16. The system for gathering and displaying information about a vaporizer liquid as recited in claim 15, wherein the code patch further comprises data comprising a brand and a flavor of the vaporizing liquid, and wherein the app displays the brand and flavor obtained from the code patch when the app is unable to access the database entry.

17. The system for gathering and displaying information about a vaporizer liquid as recited in claim 12, wherein the vaporizer housing further comprises a screen configured to display brand and flavor information associated with the at least one cartridge when the cartridge is inserted into the cartridge port.

18. The system for gathering and displaying information about a vaporizer liquid as recited in claim 17, wherein the screen of the vaporizer housing is a liquid crystal display.
